(19) United States
(12) Patent Application Publication
(10) Pub. No.: US 2026/0322723 A1
(43) Pub. Date: Oct. 15, 2026

(54) DISCOVERY OF BSS LOAD INFORMATION OF NEIGHBORING AP MLD IN A SEAMLESS ROAMING DOMAIN IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/466,151

(22) Filed: Jan. 30, 2026

Related U.S. Application Data
(60) Provisional application No. 63/756,393, filed on Feb. 10, 2025.
(60) Provisional application No. 63/756,407, filed on Feb. 10, 2025.
(60) Provisional application No. 63/924,871, filed on Nov. 25, 2025.

(51) Int. Cl. H04L 43/0876; H04W 8/00; H04W 36/18

(52) U.S. Cl. CPC H04L 43/0876; H04W 8/005; H04W 36/18

(57) ABSTRACT

Methods and apparatuses for discovery of basic service set (BSS) load information of a neighboring access point (AP) multi-link device (MLD) in a wireless local area network (WLAN). A method performed by a non-AP MLD includes receiving, from (i) a current AP MLD that is associated with a plurality of AP MLDs or (ii) a target AP MLD associated with the plurality of AP MLDs, BSS load information associated with the target AP MLD. The BSS load information includes current values of BSS load parameters associated with the BSS load information. The method includes determining a BSS load of the target AP MLD based on the current values of the BSS load parameters associated with the BSS load information.

### CROSS-REFERENCE TO RELATED APPLICATION(S) AND CLAIM OF PRIORITY

This application claims priority under 35 U.S.C. § 119(e) to U.S. Provisional Patent Application No. 63/756,393, filed on Feb. 10, 2025, U.S. Provisional Patent Application No. 63/756,407, filed on Feb. 10, 2025, and U.S. Provisional Patent Application No. 63/924,871, filed on Nov. 25, 2025, each of which are hereby incorporated by reference in their entirety.

### TECHNICAL FIELD

This disclosure relates generally to wireless communication, and more specifically to discovery of basic service set (BSS) load information of a neighboring access point (AP) multi-link device (MLD) in a seamless roaming domain in Wireless Local Area Networks (WLANs) including next generation WLANs.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for discovery of BSS load information of a neighboring AP MLD in a seamless roaming domain in WLANs.

In one embodiment, a method performed by a non-access point (AP) multi-link device (MLD) comprises receiving, from (i) a current AP MLD that is associated with a plurality of AP MLDs or (ii) a target AP MLD associated with the plurality of AP MLDs, basic service set (BSS) load information associated with the target AP MLD. The BSS load information includes current values of BSS load parameters associated with the BSS load information. The method includes determining a BSS load of the target AP MLD based on the current values of the BSS load parameters associated with the BSS load information.

In another embodiment, a method performed by a current AP MLD comprises receiving, from a target AP MLD, BSS load information associated with the target AP MLD, where the target AP MLD is associated with a plurality of AP MLDs including the current AP MLD. The BSS load information includes current values of BSS load parameters associated with the BSS load information. The method includes transmitting, to a non-AP MLD, the BSS load information for determining a BSS load of the target AP MLD.

In yet another embodiment, an electronic device comprises at least one processor including processing circuitry; and memory storing instructions, where the instructions, when executed by the at least one processor individually or collectively, cause the electronic device to: receive, from (i) a current AP MLD that is associated with a plurality of AP MLDs or (ii) a target AP MLD associated with the plurality of AP MLDs, BSS load information associated with the target AP MLD, where the BSS load information includes current values of BSS load parameters associated with the BSS load information; and determine a BSS load of the target AP MLD based on the current values of the BSS load parameters associated with the BSS load information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example BSS load element format according to embodiments of the present disclosure;

FIG. 4 illustrates an example seamless mobility domain (SMD) information element according to embodiments of the present disclosure;

FIG. 5 illustrates an example BSS load parameters information element according to embodiments of the present disclosure;

FIG. 6 illustrates an example multi-link element according to embodiments of the present disclosure;

FIG. 7 illustrates an example common information field according to embodiments of the present disclosure;

FIG. 8 illustrates an example format of a common information field according to embodiments of the present disclosure;

FIG. 9 illustrates an example of fields of a seamless roaming domain information transmission according to embodiments of the present disclosure;

FIG. 10 illustrates an example presence bitmap according to embodiments of the present disclosure;

FIG. 11 illustrates an example format of a common information field according to embodiments of the present disclosure; and

FIG. 12 illustrates an example method performed by a non-AP MLD in a wireless communication system according to embodiments of the present disclosure.

### DETAILED DESCRIPTION

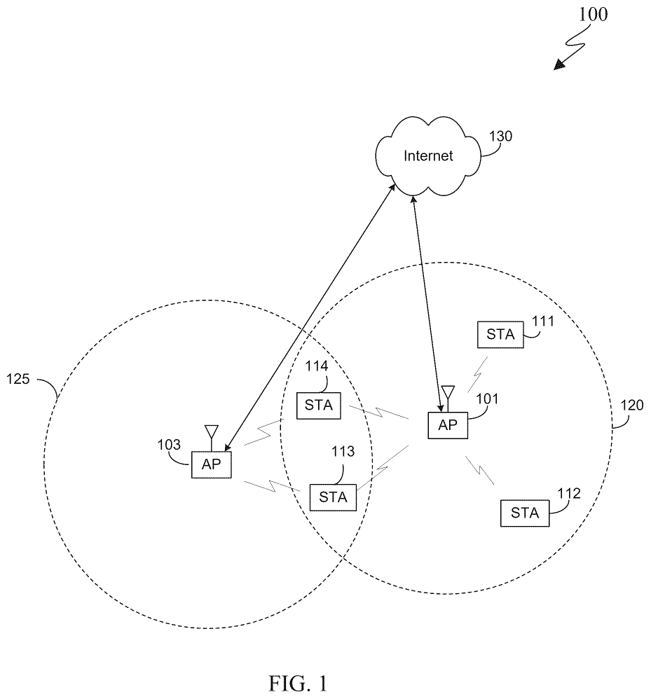

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024; [2] IEEE Std 802.11-2020; and [3] IEEE P802.11bn/D0.1, 2025.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating discovery of BSS load information of a neighboring AP MLD in a seamless roaming domain in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

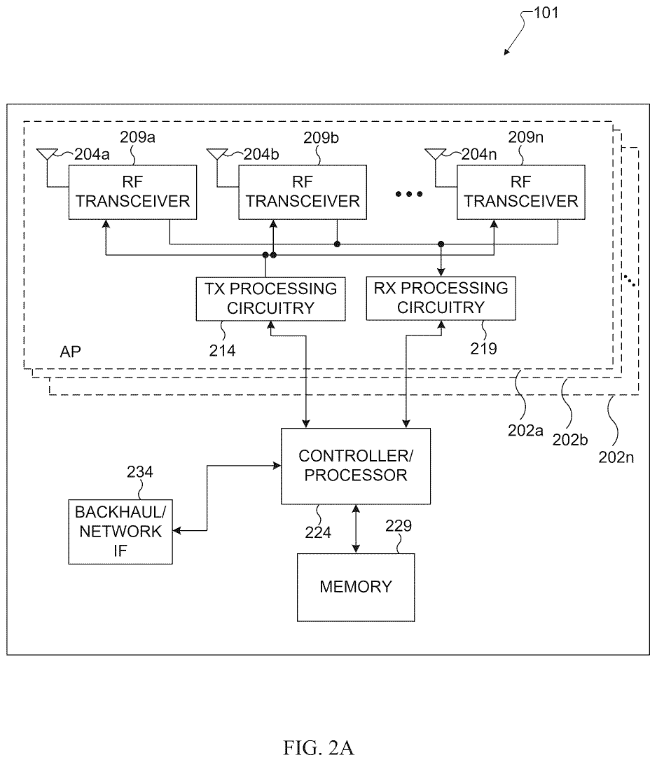

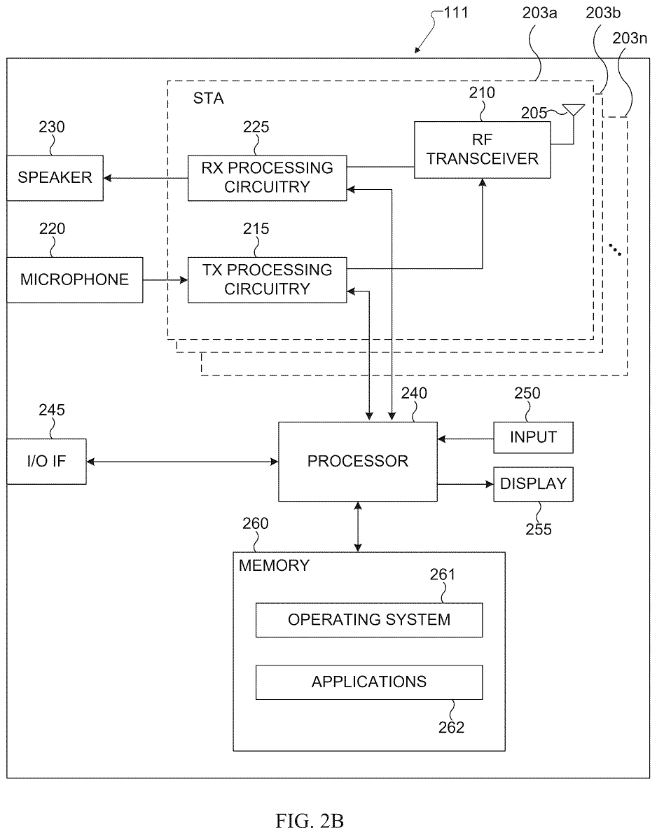

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHZ, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including DL data handling in seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating discovery of BSS load information of a neighboring AP MLD in a seamless roaming domain in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate discovery of BSS load information of a neighboring AP MLD in a seamless roaming domain in WLANs. In some embodiments, the processor 240 includes at least one microprocessor or microcontroller.

The processor 240 is also capable of executing other processes and programs resident in the memory 260, such as operations for facilitating discovery of BSS load information of a neighboring AP MLD in a seamless roaming domain in WLANs. The processor 240 can move data into or out of the memory 260 as required by an executing process. In some embodiments, the processor 240 is configured to execute a plurality of applications 262, such as applications for facilitating discovery of BSS load information of a neighboring AP MLD in a seamless roaming domain in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

The goal of seamless roaming is to provide mechanisms for a non-AP MLD to transition from the current AP MLD to the target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the stages are a preparation stage and roam execution stage. During the preparation stage, the non-AP MLD can setup links with the target AP MLD and perform context transfer. Following this stage, the non-AP MLD can perform a roam execution procedure by sending a request frame to transition from current AP MLD to target AP MLD. The current AP MLD can process the request frame and send a response frame to the non-AP MLD after the transfer of context is complete.

These procedures can enable the non-AP MLD to seamlessly roam from the current AP MLD to the target AP MLD.

Embodiments of the present disclosure recognize scenarios where a non-AP MLD has one or more non-AP STAs affiliated with it. The non-AP MLD is capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can perform an SMD BSS transition procedure between the AP MLDs while maintaining association with the seamless mobility domain management entity (SMD-ME). The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. At a time, only one of the two data paths can be used.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further an AP MLD can use the BTM framework to recommend one or more candidate target AP MLDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support and constraints at the target AP MLD.

When the non-AP MLD uses SMD BSS transition to transition from an AP MLD (referred to as the current AP MLD without loss of generality) to another AP MLD within the same SMD (referred to as the target AP MLD), the non-AP MLD can perform an SMD BSS transition preparation procedure. The preparation procedure can be performed in advance before the transition occurs. The preparation procedure can be performed by transmitting a preparation request frame to the current AP MLD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, SCS, MSCS, EPCS, etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MLD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MLD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MLD. The target AP MLD can transmit an execution response frame to the non-AP MLD.

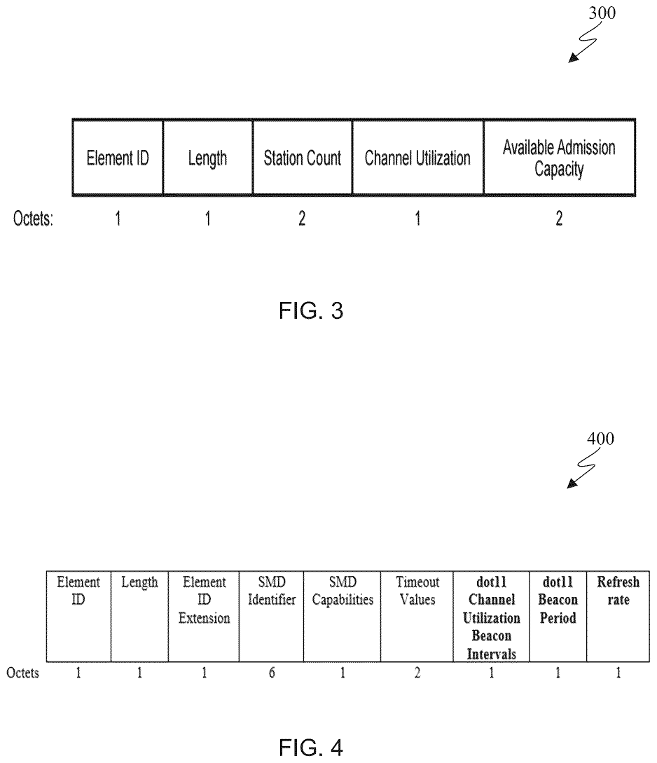

FIG. 3 illustrates an example BSS load element format 300 according to embodiments of the present disclosure. The embodiment of the example BSS load element format 300 shown in FIG. 3 is for illustration only. Other embodiments of the example BSS load element format could be used without departing from the scope of this disclosure.

When a non-AP MLD has setup links with an AP MLD that is a part of an SMD, the non-AP MLD can need complete information about the other AP MLDs that are a part of the same domain as its current AP MLD. Information such as that related to BSS load can be useful for the non-AP MLD. The AP MLD can share BSS load related information with the non-AP MLD via a BSS load element.

As illustrated in FIG. 3, the BSS load can carry information such as station count, channel utilization and available admission capacity. The Station Count field indicates the total number of STAs currently associated with this BSS. The Channel Utilization field is defined as the percentage of time, linearly scaled with 255 representing 100%, that the AP sensed the medium was busy, as indicated by either the physical or virtual carrier sense (CS) mechanism. When more than one channel is in use for the BSS, the Channel Utilization field value is calculated only for the primary channel. This percentage is computed using the following formula:

$$\frac{( 255 * channel busy time )}{\begin{matrix}( dot 11 ChannelUtilizationBeaconIntervals * \\ dot 11 BeaconPeriod * 1024 )\end{matrix}}$$

where channel busy time can be defined to be the number of microseconds during which the carrier sense has a mechanism indicated channel busy indication, dot11ChannelUtilizationBeaconIntervals can represent the number of consecutive beacon intervals during which the channel busy time is measured, and dot11BeaconPeriod can represent the interval between consecutive beacon frame transmissions.

The Available Admission Capacity field contains an unsigned integer that specifies the remaining amount of medium time available via explicit admission control, in units of 32 μs/s. The field is helpful for BSS transitioning STAs to select an AP that is likely to accept future admission control requests, but it does not represent an assurance that the HC admits these requests.

The non-AP MLD can use this information to rank neighbor AP MLDs and chose which ones to perform a preparation procedure with. Unfortunately, the non-AP MLD does not know the details of the BSS load information that is shared by the current AP MLD i.e., it does not know how different parameters have been computed.

For instance, the non-AP MLD does not know the dot11ChannelUtilizationBeaconIntervals value and dot11BeaconPeriod. Further, it does not know the refresh rate of this value i.e., how frequently has this value been updated or recomputed for the neighbor AP MLD for which it is being reported.

Without this information, the non-AP MLD cannot understand how to interpret this value and if it is stale. Procedures and signaling are needed to provide the non-AP MLD with the complete information related to the BSS load of other AP MLDs of the same UHR seamless roaming domain as the current AP MLD.

When an AP MLD advertises information about itself, the non-AP MLD does not know if the AP MLD is a part of a UHR seamless roaming domain or not. A signaling is needed by which the non-AP MLD can identify that an AP MLD is a part of a UHR seamless roaming domain.

In this disclosure, a number of solutions are presented for handling discovery of other AP MLDs that are a part of the UHR seamless roaming domain, including:
1. Uniform parameters across all AP MLDs in an SMD
2. Different parameters for different AP MLDs in an SMD
3. Non-AP MLD based request to change BSS load element related parameters for an AP
4. Current AP MLD reporting the parameters for an AP for which it does not know the BSS load element related parameters
5. Information content in a multi-link element
6. Modified basic multi-link element
7. New multi-link element variant
8. UHR seamless roaming domain affiliation indication

### 1. Uniform Parameters Across all AP MLDs in an SMD

According to one embodiment, all AP MLDs in an SMD can use the same parameters related to BSS load i.e., the same values for dot11ChannelUtilizationBeaconIntervals and dot11BeaconPeriod when computing the BSS load. Further, all AP MLDs in the same SMD can use the same refresh rate when fetching updated values corresponding to the fields in the BSS load element for reported AP MLDs that are their neighbor AP MLDs. In the remainder of this disclosure, the term ‘BSS load element related parameters’ can be used to refer to one or more or all of dot11ChannelUtilizationBeaconIntervals, dot11BeaconPeriod and refresh rate.

FIG. 4 illustrates an example seamless mobility domain (SMD) information element 400 according to embodiments of the present disclosure. The embodiment of the example SMD information element 400 shown in FIG. 4 is for illustration only. Other embodiments of the example SMD information element could be used without departing from the scope of this disclosure.

The values can be advertised by an AP MLD of an SMD in an SMD information element which can be transmitted in management frames such as beacons, probe responses, (re)association responses, etc.

The modified SMD information element can have additional fields as illustrated in FIG. 4.

The dot11ChannelUtilizationBeaconIntervals and dot11BeaconPeriod can take a value that can be used for computation of channel utilization for AP MLDs in the SMD. The refresh rate can take a value of refresh rate for the SMD.

The above information can also be advertised in a neighbor report element.

Further, if the values of these parameter changes, the current AP MLD can also provide the update in the form of an enhanced BSS parameter critical update.

### 1.1 Information Sharing During the Probing Phase:

According to one embodiment, the information can be shared in a probe response frame transmitted to the non-AP MLD.

According to this embodiment, the non-AP MLD can transmit a probe response frame to a target AP MLD. If the target AP MLD transmits a BSS load element in the probe response frame, the target AP MLD can include an SMD information element with the BSS load element related parameters in the probe response frame.

According to one embodiment, the non-AP MLD can explicitly indicate in the probe request frame that it requests the BSS load element related parameters to be present in the probe response frame. When a target AP MLD receives a probe request with such an indication, the target AP MLD can transmit the BSS load element related parameters in the probe response frame. Further according to this embodiment, when the non-AP MLD does not make the indication, the target AP MLD can transmit a probe response without the BSS load element related parameters.

According to another embodiment, the non-AP MLD can transmit an ML probe request frame to the current AP MLD and if the current AP MLD includes the BSS load element for a target AP MLD in the probe response frame, the current AP MLD can also include BSS load element related parameters.

The non-AP MLD can compare the BSS load for different AP MLDs and chose the correct target AP MLD(s) to perform preparation. Since the values are same, the comparison can be a fair comparison.

### 1.2 Information Sharing During (Re)Association Phase:

According to one embodiment, the non-AP MLD can transmit a (re) association request frame to an AP MLD in the SMD. The AP MLD can transmit a (re) association response frame with the BSS load element related parameters.

### 1.3 Information Sharing During Recommendation Phase:

The non-AP MLD can transmit a BTM query frame to the current AP MLD. The current AP MLD can gather information or use cached information about the neighbor AP MLDs in the SMD and can transmit a BTM request frame that can contain a neighbor report element that can carry the BSS load element related parameters.

According to one embodiment, the BSS load element related parameters can be shared with the non-AP MLD by the current or target AP MLD when solicited by the non-AP MLD or in an unsolicited manner.

### 1.4 Non-AP MLD Procedure to Obtain the Latest Update:

According to one embodiment, if the non-AP MLD wants to obtain the latest BSS load element for a target AP MLD via the current AP MLD, the non-AP MLD can transmit a frame with an indication that it needs the latest BSS load element for the non-AP MLD. Upon receiving this indication, the BSS load element can be fetched from the target AP MLD again. According to one embodiment, the target AP MLD can compute the parameters of the BSS load element when the information is fetched.

According to another embodiment, the target AP MLD can send the same BSS load element that it has computed during the last time it computed the parameters.

The current AP MLD can also advertise if such a request for a latest update can be made or not. If advertised, then the non-AP MLD can transmit the above frame.

If the advertisement is not made and the non-AP MLD transmits the frame, then the non-AP MLD's request can be rejected by the AP MLD.

### 2. Different Parameters for Different AP MLDs in an SMD

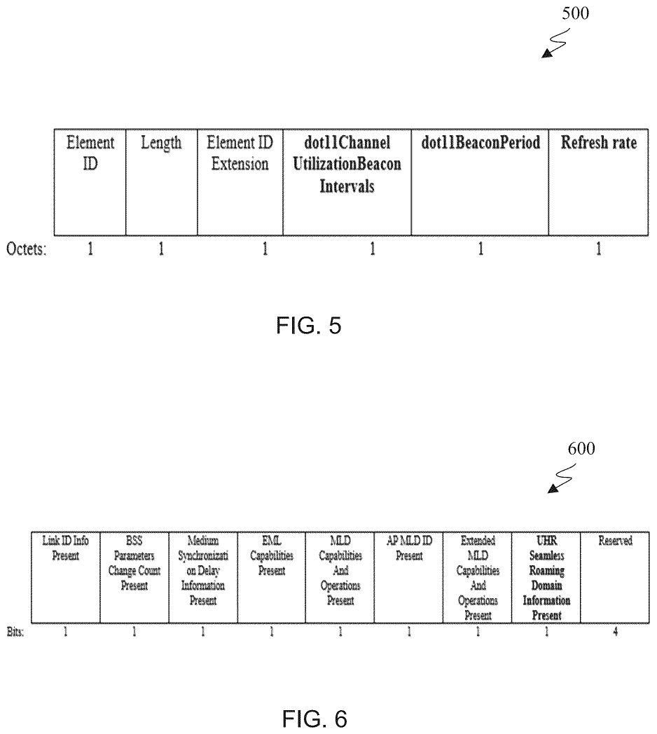

FIG. 5 illustrates an example BSS load parameters information element 500 according to embodiments of the present disclosure. The embodiment of the example BSS load parameters information element 500 shown in FIG. 5 is for illustration only. Other embodiments of the example BSS load parameters information element could be used without departing from the scope of this disclosure.

According to one embodiment, a BSS load parameters information element can carry the BSS load element related parameters. The BSS load parameters information element can have a format as shown in FIG. 5.

The non-AP MLD can transmit a BTM query frame to the current AP MLD. When the current AP MLD transmits a BTM request frame to the non-AP MLD, the neighbor report element can carry a BSS load parameters information element inside it for a reported AP if a BSS load element was also present corresponding to that AP in the BTM request frame.

The values in the different fields in the BSS load parameters information element can be populated by fetching those values from the target AP MLD or based on values for the target AP MLD that are cached at the current AP MLD.

### 3. Non-AP MLD Based Request to Change BSS Load Element Related Parameters for an AP

According to one embodiment, the non-AP MLD can transmit the BSS load parameters information element in a frame to the current AP MLD. Based on reception of the frame, the current AP MLD can request the target AP MLD to compute the fields in the BSS load element and provide that BSS load element to the non-AP MLD.

The frame transmitted by the non-AP MLD can be a BTM query frame and the response frame from the current AP MLD can be a BTM request frame.

4. Current AP MLD Reporting the Parameters for an AP for which it does not Know the BSS Load Element Related Parameters

According to one embodiment, the current AP MLD may not know the BSS load element related parameters for a target AP MLD. According to this embodiment, the current AP MLD can transmit a BSS load parameters information element that carries some reserved or pre-known values/encoding to indicate that the current AP MLD does not have the information related to the BSS load element related parameters for a target AP MLD.

### 5. Information Content in a Multi-Link Element

According to one embodiment, the information of another AP MLD in the same seamless roaming domain as the current AP MLD can be carried in a multi-link element. This multi-link element can be transmitted by the current AP MLD to provide information of the other AP MLD to its associated non-AP MLDs.

The multi-link element can carry at least one or more of the information items as described in Table 1.

TABLE 1
Information items that can be carried in a multi-link element

| Information items | Description |
|---|---|
| AP MLD identifier | One or more information items that can indicate the AP MLD that |
| | the information corresponds to. |
| AP MLD information | One or more information items that can indicate the information |
| | associated with the AP MLD. |
| Link level information | One or more information items that can provide the information |
| | associated with each link associated with the AP MLD. |
| UHR seamless | One or more information items that can indicate that the |
| roaming domain AP | information contained in the multi-link element corresponds to an |
| MLD indication | AP MLD that is in the same UHR seamless roaming domain as |
| | the current AP MLD. This can enable a non-AP MLD to |
| | understand that the information does not correspond to the current |
| | AP MLD and rather to another AP MLD from the same seamless |
| | roaming domain. |

### 6. Modified Basic Multi-Link Element

FIG. 6 illustrates an example multi-link element 600 according to embodiments of the present disclosure. The embodiment of the example multi-link element 600 shown in FIG. 6 is for illustration only. Other embodiments of the example multi-link element could be used without departing from the scope of this disclosure.

According to one embodiment, the information of the other AP MLDs can be carried in a modified basic multi-link element as follows.

The presence bitmap in the multi-link control field of the basic multi-link element can carry a UHR seamless roaming domain AP MLD information present indicator as shown in FIG. 6.

The UHR Seamless Roaming Domain Information Present bit can be set to 1 if the basic multi-link element carries information on AP MLDs that are a part of the UHR seamless roaming domain.

According to one embodiment, when the basic multi-link element carries information of other UHR seamless roaming domain AP MLDs, it cannot carry information of the current AP MLD.

According to another embodiment, when the basic multi-link element carries information of other UHR seamless roaming domain AP MLDs, it can carry information of the current AP MLD.

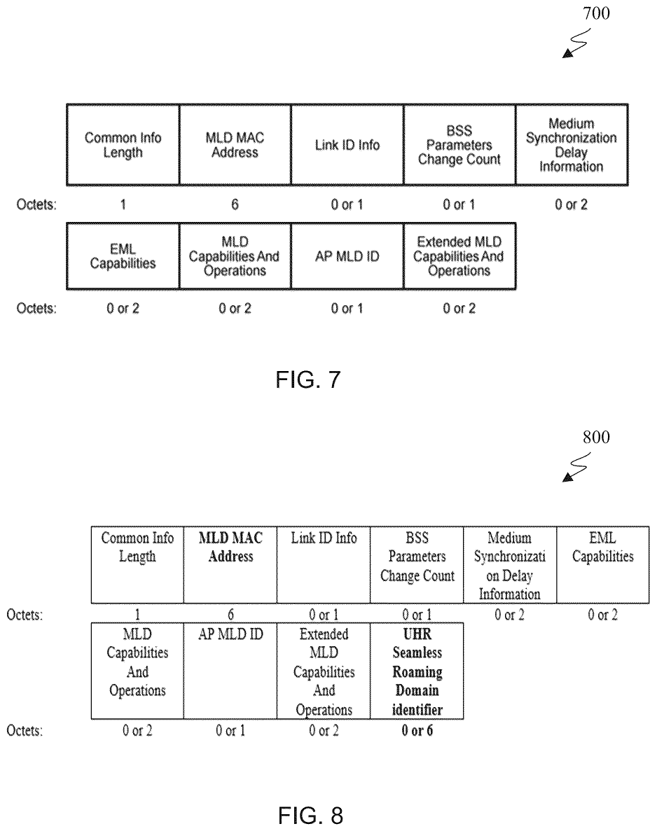

FIG. 7 illustrates an example common information field 700 according to embodiments of the present disclosure. The embodiment of the example common information field 700 shown in FIG. 7 is for illustration only. Other embodiments of the example common information field could be used without departing from the scope of this disclosure.

The MLD MAC address in the common information field of the basic multi-link element can be set to the MLD MAC address of the AP MLD (not the current AP MLD) of the UHR seamless roaming domain.

The per-STA profile in the basic multi-link element can carry the link specific information for each of the affiliated STA of the MLD.

If the target AP MLD is a single link device, then the per-STA profile can carry a single per-STA profile.

When the current AP MLD advertises a basic multi-link element, it can transmit one basic multi-link element for each AP MLD in the UHR seamless roaming domain.

### 7. New Multi-Link Element Variant

According to another embodiment, there can be a new multi-link element variant (hereby referred to as the seamless roaming multi-link element) to advertise the information of other AP MLDs of the UHR seamless roaming domain. The type subfield in the multi-link control field can have an encoding as shown in Table 2.

TABLE 2

| Type subfield encoding | |
|---|---|
| Type subfield | Multi-link element variant |
| value | name |
| 0 | Basic |
| 1 | Probe Request |
| 2 | Reconfiguration |
| 3 | TDLS |
| 4 | Priority Access |
| 5 | Seamless Roaming |
| 6-7 | Reserved |

FIG. 8 illustrates an example format of a common information field according to embodiments of the present disclosure. The embodiment of the example common information field 800 shown in FIG. 8 is for illustration only. Other embodiments of the example common information field could be used without departing from the scope of this disclosure.

The common information field of the seamless roaming multi-link element can have at least one or more of the subfields of the basic multi-link element.

According to one embodiment, the MLD MAC address can be set to the MLD MAC address of the AP MLD of the UHR seamless roaming domain. The per-STA profile can have the per-STA profile of the AP MLD.

According to one embodiment, the common information field of the seamless roaming domain can have the format as shown in FIG. 8.

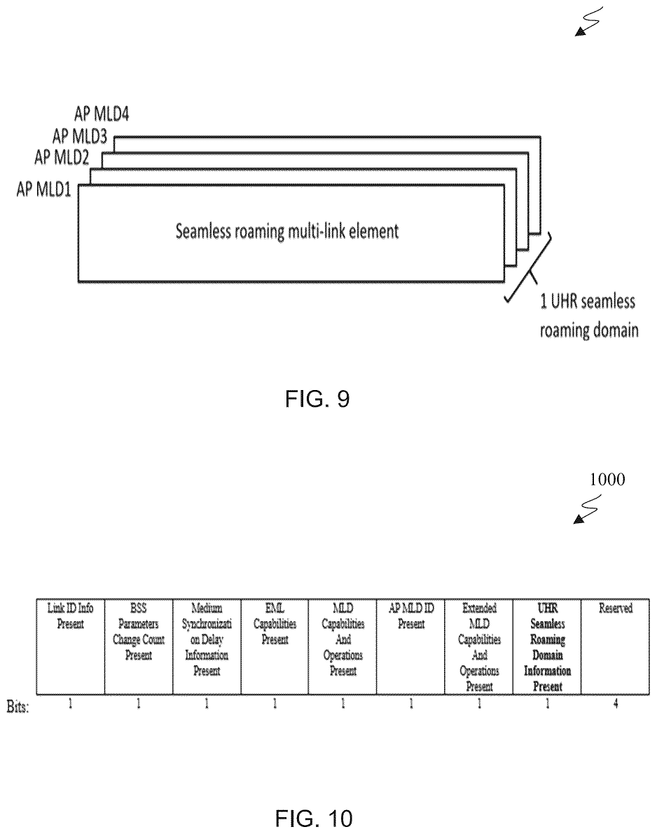

FIG. 9 illustrates an example of fields of a seamless roaming domain information transmission 900 according to embodiments of the present disclosure. The embodiment of the example of fields of a seamless roaming domain information transmission 900 shown in FIG. 9 is for illustration only. Other embodiments of the example of fields of a seamless roaming domain information transmission could be used without departing from the scope of this disclosure.

The UHR Seamless Roaming Domain identifier can be set to the MAC address or another form of identifier of the UHR seamless roaming domain that the AP MLD indicated in the MLD MAC address belongs to.

The per-STA profile can carry the per-STA profile for each of the STAs affiliated with that AP MLD.

An example diagram showing key fields of the seamless roaming domain information transmission can be as depicted in FIG. 9.

The seamless roaming ML element can be included in probe responses that are received from the current AP MLD. The probe request can provide an indication that the non-AP MLD is probing for information of neighbor AP MLDs that are a part of the same UHR seamless roaming domain.

The seamless roaming ML element can also be included in neighbor report element.

The seamless roaming ML element can also be included in beacons.

### 8. UHR Seamless Roaming Domain Affiliation Indication

### 8.1 Advertisement in Basic Multi-Link Element

FIG. 10 illustrates an example presence bitmap 1000 according to embodiments of the present disclosure. The embodiment of the example presence bitmap 1000 shown in in FIG. 10 is for illustration only. Other embodiments of the example presence bitmap could be used without departing from the scope of this disclosure.

According to one embodiment, the presence bitmap in the multi-link control field of the basic multi-link element can carry a UHR seamless roaming domain AP MLD information present indicator as shown in FIG. 10.

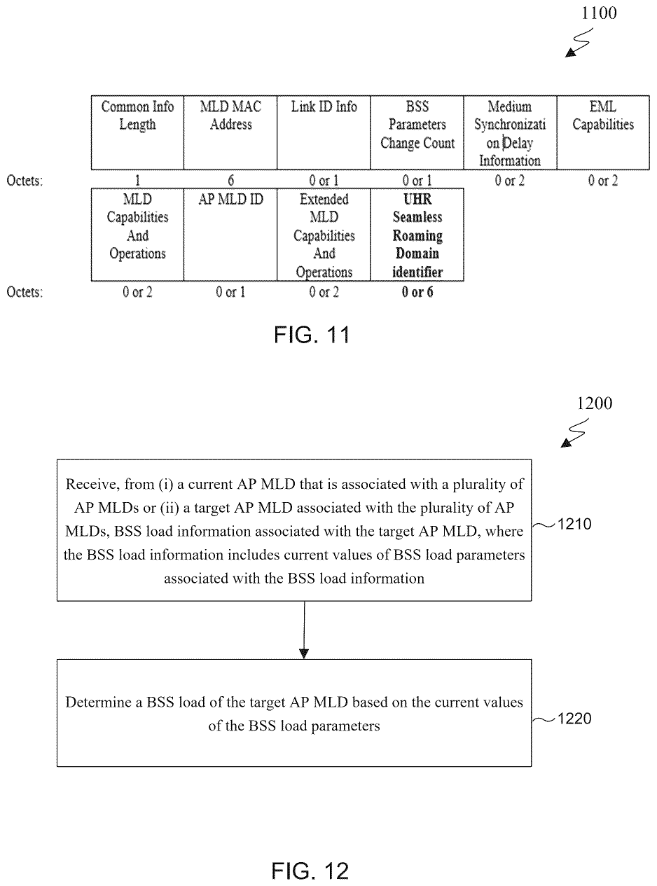

FIG. 11 illustrates an example format of a common information field 1100 according to embodiments of the present disclosure. The embodiment of the example format of a common information field 1100 shown in in FIG. 11 is for illustration only. Other embodiments of the example format of a common information field could be used without departing from the scope of this disclosure.

The UHR Seamless Roaming Domain Information Present bit can be set to 1 if the basic multi-link element carries information on the UHR seamless roaming domain.

According to one embodiment, the common information field of the basic multi-link element can contain a UHR seamless roaming domain identifier. The identifier can be the MAC address of the UHR seamless roaming domain.

This information can inform the non-AP MLD that an AP MLD can be a part of a UHR seamless roaming domain and also provide the identifier of the domain that it can be a part of.

According to one embodiment, when the UHR Seamless Roaming Domain Information Present bit in the modified presence bitmap subfield is set to 1, the common information field can contain the UHR seamless roaming domain identifier.

FIG. 12 illustrates an example method 1200 performed by a non-AP MLD in a wireless communication system according to embodiments of the present disclosure. The method 1200 of FIG. 12 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 1200 is for illustration only and other embodiments can be used without departing from the scope of the present disclosure.

As illustrated in FIG. 12, the method 1200 begins at step 1210, where the non-AP MLD receives, from (i) a current AP MLD that is associated with a plurality of AP MLDs or (ii) a target AP MLD associated with the plurality of AP MLDs, BSS load information associated with the target AP MLD. The BSS load information includes current values of BSS load parameters associated with the BSS load information. At step 1220, the non-AP MLD determines a BSS load of the target AP MLD based on the current values of the BSS load parameters associated with the BSS load information.

In some embodiments, the current values of the BSS load parameters associated with the BSS load information are same for each of the plurality of AP MLDs.

In some embodiments, the non-AP MLD receives the BSS load information in an information element via a management frame.

In some embodiments, the BSS load parameters associated with the BSS load information comprise dot11ChannelUtilizationBeaconIntervals, dot11BeaconPeriod, and refresh rate.

In some embodiments, the non-AP MLD receives the BSS load information in a neighbor report element via a management action frame.

In some embodiments, the non-AP MLD transmits, to the current AP MLD or to the target AP MLD, a probe request frame; receives, from the current AP MLD or the target AP MLD, a probe response frame that includes the BSS load information; and compares the BSS load for different AP MLDs of the plurality of AP MLDs.

In some embodiments, the non-AP MLD transmits, to the current AP MLD or to the target AP MLD, an association request frame; receives, from the current AP MLD or the target AP MLD, an association response frame that includes the BSS load information; and compares the BSS load for different AP MLDs of the plurality of AP MLDs.

In some embodiments, the non-AP MLD transmits, to the current AP MLD, a BSS BTM query frame; receives, from the current AP MLD, a BTM request frame that includes the BSS load information; and compares the BSS load for different AP MLDs of the plurality of AP MLDs.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a non-access point (AP) multi-link device (MLD), the method comprising:
receiving, from (i) a current AP MLD that is associated with a plurality of AP MLDs or (ii) a target AP MLD associated with the plurality of AP MLDs, basic service set (BSS) load information associated with the target AP MLD, wherein the BSS load information includes current values of BSS load parameters associated with the BSS load information; and
determining a BSS load of the target AP MLD based on the current values of the BSS load parameters associated with the BSS load information.

2. The method of claim 1, wherein the current values of the BSS load parameters associated with the BSS load information are same for each of the plurality of AP MLDs.

3. The method of claim 2, wherein receiving the BSS load information further comprises receiving the BSS load information in an information element via a management frame.

4. The method of claim 3, wherein the BSS load parameters associated with the BSS load information comprise dot11ChannelUtilizationBeaconIntervals, dot11BeaconPeriod, and refresh rate.

5. The method of claim 2, wherein receiving the BSS load information further comprises receiving the BSS load information in a neighbor report element via a management action frame.

6. The method of claim 1, further comprising:
transmitting, to the current AP MLD or to the target AP MLD, a probe request frame;
receiving, from the current AP MLD or the target AP MLD, a probe response frame that includes the BSS load information; and
comparing the BSS load for different AP MLDs of the plurality of AP MLDs.

7. The method of claim 1, further comprising:
transmitting, to the current AP MLD or to the target AP MLD, an association request frame;
receiving, from the current AP MLD or the target AP MLD, an association response frame that includes the BSS load information; and
comparing the BSS load for different AP MLDs of the plurality of AP MLDs.

8. The method of claim 1, further comprising:
transmitting, to the current AP MLD, a BSS transition management (BTM) query frame;
receiving, from the current AP MLD, a BTM request frame that includes the BSS load information; and
comparing the BSS load for different AP MLDs of the plurality of AP MLDs.

9. A method performed by a current access point (AP) multi-link device (MLD), the method comprising:
receiving, from a target AP MLD, basic service set (BSS) load information associated with the target AP MLD, wherein the target AP MLD is associated with a plurality of AP MLDs including the current AP MLD, and wherein the BSS load information includes current values of BSS load parameters associated with the BSS load information; and
transmitting, to a non-AP MLD, the BSS load information for determining a BSS load of the target AP MLD.

10. The method of claim 9, wherein the current values of the BSS load parameters associated with the BSS load information are same for each of the plurality of AP MLDs.

11. The method of claim 10, wherein transmitting the BSS load information further comprises transmitting the BSS load information in an information element via a management frame.

12. The method of claim 11, wherein the BSS load parameters associated with the BSS load information comprise dot11ChannelUtilizationBeaconIntervals, dot11BeaconPeriod, and refresh rate.

13. The method of claim 10, wherein receiving the BSS load information further comprises receiving the BSS load information in a neighbor report element via a management action frame.

14. The method of claim 9, further comprising:
receiving, from the non-AP MLD, a probe request frame; and
transmitting, to the non-AP MLD, a probe response frame that includes the BSS load information.

15. An electronic device comprising:
at least one processor including processing circuitry; and
memory storing instructions, wherein the instructions, when executed by the at least one processor individually or collectively, cause the electronic device to:
receive, from (i) a current access point (AP) multi-link device (MLD) that is associated with a plurality of AP MLDs or (ii) a target AP MLD associated with the plurality of AP MLDs, basic service set (BSS) load information associated with the target AP MLD, wherein the BSS load information includes current values of BSS load parameters associated with the BSS load information; and
determine a BSS load of the target AP MLD based on the current values of the BSS load parameters associated with the BSS load information.

16. The electronic device of claim 15, wherein the current values of the BSS load parameters associated with the BSS load information are same for each of the plurality of AP MLDs.

17. The electronic device of claim 16, wherein the instructions, when executed by the at least one processor individually or collectively, cause the electronic device to receive the BSS load information in an information element via a management frame.

18. The electronic device of claim 17, wherein the BSS load parameters associated with the BSS load information comprise dot11ChannelUtilizationBeaconIntervals, dot11BeaconPeriod, and refresh rate.

19. The electronic device of claim 16, wherein the instructions, when executed by the at least one processor individually or collectively, cause the electronic device to receive the BSS load information in a neighbor report element via a management action frame.

20. The electronic device of claim 15, wherein the instructions, when executed by the at least one processor individually or collectively, cause the electronic device to:
transmit, to the current AP MLD or to the target AP MLD, a probe request frame;
receive, from the current AP MLD or the target AP MLD, a probe response frame that includes the BSS load information; and
compare the BSS load for different AP MLDs of the plurality of AP MLDs.
